(19) United States
(12) Patent Application Publication
(10) Pub. No.: US 2025/0167429 A1
(43) Pub. Date: May 22, 2025

(54) TEN ELEMENT SINGLE-BAND MIMO ANTENNA FOR 5G SMARTPHONES

(71) Applicant: KING FAHD UNIVERSITY OF PETROLEUM AND MINERALS, Dhahran (SA)

(72) Inventors: Rifaqat HUSSAIN, Dhahran (SA); Durria ABBASI, Bahawalpur (PK); Abdul AZIZ, Bahawalpur (PK); Sharif Iqbal Mitu SHEIKH, Dhahran (SA)

(73) Assignee: KING FAHD UNIVERSITY OF PETROLEUM AND MINERALS, Dhahran (SA)

(21) Appl. No.: 18/512,240

(22) Filed: Nov. 17, 2023

(51) Int. Cl. H01Q 1/24; H01Q 5/371; H01Q 9/04; H01Q 21/06; H04B 7/0404

(52) U.S. Cl. CPC H01Q 1/243; H01Q 5/371; H01Q 9/0407; H01Q 21/065; H04B 7/0404

(57) ABSTRACT

A ten element dual band multiple-input multiple-output (MIMO) antenna for a smartphone configured for radiation at a resonant frequency of approximately 3.5 GHz. A substrate, having a top side, a bottom side, and four distinct side walls, accommodates ten single-element dual-band antennas distributed evenly along outer surfaces of two opposite side walls. Each antenna element includes a meandered slot line comprising two arms linked by a straight leg, with the arms connected to a ground plane situated on bottom side of the substrate. Parallel to the straight legs are ten T-shaped feed structures, housed on the inner surfaces of the two opposite side walls, facilitating connectivity through feed ports also located on the bottom side of the substrate. Each antenna element within the ten-element dual-band MIMO antenna array effectively radiates in response to electrical signals directed to their corresponding feed ports, achieving efficient performance at the designated resonant frequency.

### CROSS REFERENCE TO RELATED APPLICATIONS

The present application is related to “12×12 Dual-Band MIMO Antenna For 5G Smartphones”, attorney docket number 547016US, filed on Nov. 17, 2023, which is incorporated herein by reference in its entirety.

### BACKGROUND

### Technical Field

The present disclosure is directed to a single-band multiple-input multiple-output (MIMO) antenna system, having antenna elements arranged in a specific geometric configuration in which five antenna elements are arranged parallel to and opposite a second five antenna elements on an outer side of opposite side walls of a substrate, and a method for wireless communication that achieves radiation diversity in a fifth generation (5G) system.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Fifth generation (5G) mobile communication technology offers several advantages such as high communication rates, low latency, large connection density, and high communication capacity. To meet these goals and improve the channel capacity in a rich scattering environment, MIMO antennas have become a key technology in the new generation of wireless communication systems. MIMO technology involves the incorporation of multiple antenna elements at both the transmitting and receiving ends, thereby not only mitigating fading losses but also substantially augmenting data throughput capacities beyond the limitations imposed by single-input-single-output (SISO) systems. MIMO antennas enhance channel capacity through multiple independently placed elements, but due to the narrow space of terminals, spatial diversity cannot always be achieved. Therefore, other diversity techniques such as polarization diversity and radiation pattern diversity are used in MIMO systems. Integration of a large number of antenna elements within the limited space of a MIMO system (such as a base station, mobile terminal, or both) on the scale required for 5G applications is typically referred to as Massive MIMO. However, the MIMO system is subject to problems, such as the multipath propagation problem due to high correlation in multiple signal broadcasting, as well as mutual coupling within the MIMO system. Mutual coupling refers to the amount of cross-talk between the independent radiating sources. Mutual coupling can be a result of surface wave propagation and space wave coupling in the MIMO antenna near field, and it can impact the system performance significantly. Additionally, isolation and the envelope correlation coefficient (ECC) are degraded due to mutual coupling. This ECC degradation results in lower data capacity and system performance.

Current technological paradigms have been implemented in the art to enhance isolation between MIMO antenna elements. Examples of decoupling techniques include integration of parasitic elements, frequency reconfiguration, neutralization lines, utilization of defected ground structures (DGS), employment of electromagnetic bandgap structures (EBG) to augment isolation between MIMO antenna elements, use of metamaterials, decoupling resonators, and complementary split ring resonators (CSRR). Nonetheless, these endeavors have predominantly failed in achieving effective decoupling at frequencies exceeding 12 GHz, thus such techniques have not resulted in elements that are suitable for 5G applications or other high-frequency applications.

Patent application US20130285876A1 discloses a dual band antenna with circular polarization applied in a handheld device and including a substrate, a radiation metal portion and a feed-in stripline. However, due to its utilization as a single antenna, the data throughput capabilities are limited. Further, antenna placement on the inside edge of the substrate limits the radiation efficiency and affects the overall performance of the wireless communication system.

A miniaturized 3-D cubic antenna was described for use in a wireless sensor network (WSN) and RFIDs for environmental sensing. (See: Catherine M. Kruesi, Rushi J. Vyas, Manos M. Tentzeris, “Design and development of a novel 3-D cubic antenna for wireless sensor networks (WSNS) and RFID applications”). The single antenna design and complex 3D structure resulted in reducing the efficiency of the antenna and generated inconsistencies in performance. The miniaturized 3-D cubic antenna was also limited to specific applications, such RFID applications.

A MIMO antenna for 5G mobile terminals has been described (See: Z. Ren, A. Zhao, and S. Wu, “MIMO antenna with compact decoupled antenna pairs for 5G mobile terminals,” IEEE Antennas Wirel. Propag. Lett., vol. 18, no. 7, pp. 1367-1371, 2019). However, this antenna included two decoupled antenna pairs, which were are designed to operate in the 2.5 GHz band.

A MIMO antenna having two asymmetrically mirrored gap-coupled loop antennas has been described (See: K.-L. Wong, C.-Y. Tsai, and J.-Y. Lu, “Two asymmetrically mirrored gap-coupled loop antennas as a compact building block for eight-antenna MIMO array in the future smartphone,” IEEE Trans. Antennas Propag., vol. 65, no. 4, pp. 1765-1778, 2017). However, the described antenna has an efficiency in a range of only 42%-52%.

A conventional four-element multiple-input multiple-output (MIMO) antennas for 5G mobile terminals has been described design of PDFA operating around 1.3 μm has a gain performance of 20.4 dB (See: C. Deng, D. Liu, and X. Lv, “Tightly arranged four-element MIMO antennas for 5G mobile terminals,” IEEE Trans. Antennas Propag., vol. 67, no. 10, pp. 6353-6361, 2019). This conventional antenna has a poor efficiency (in the range of 36%-52%).

A high-isolated MIMO antenna has been described (See: Z. Xu and C. Deng, “High-isolated MIMO antenna design based on pattern diversity for 5G mobile terminals,” IEEE Antennas Wirel. Propag. Lett., vol. 19, no. 3, pp. 467-471, 2020). However, the antenna elements of this antenna have a size of 25×10.5 mm², thereby a limited number of antenna elements.

However, the antenna and methods described in the references above and other conventional antennas suffer from various limitations including larger size, required specific components (use of varactor diodes), and complicated structures.

Hence, there is a need for a multi-element dual band MIMO antenna that is configured to operate with 5G communication applications and has a small size, requires no specific external decoupling structures, and provides effective isolation. The MIMO antenna of the present disclosure has low mutual coupling that can facilitate high data throughput, diminished latency, and enhanced channel capacity of wireless communication in mobile devices.

### SUMMARY

In an exemplary embodiment, a ten-element dual band multiple-input multiple-output (MIMO) antenna for a smartphone is described. The MIMO antenna includes a substrate, ten single element dual band antennas and ten T-shaped feed structures. The substrate has a top side, a bottom side, a first side wall, a second side wall opposite the first side wall, a third side wall perpendicular to the first side wall and a fourth side wall opposite to the third side wall. First five antennas of the ten single element dual band antennas are spaced evenly along an outer surface of the first side wall and a second five antennas of the ten single element dual band antennas are spaced evenly along an outer surface of the second side wall. Each single element dual band antenna includes a meandered slot line having a first arm and a second arm. The first arm and the second arm are connected by a straight leg. A first five feed structures of the ten T-shaped feed structures are located an inner surface of the first side wall and a second five of the ten T-shaped feed structures are located on an inner surface of the second side wall. Each T-shaped feed structure is located parallel to the straight leg and centered between the first arm and the second arm of a respective antenna. Each T-shaped feed structure is connected through to a feed port located on the bottom side. A ground plane is located on the bottom side of the substrate, wherein the first arm and the second arm are connected to the ground plane. Each antenna of the ten element dual band MIMO antenna is configured to radiate at a resonant frequency of about 3.5 GHz in response to an electrical signal applied to its respective feed port.

In another exemplary embodiment, a smartphone having a ten element dual band MIMO antenna is described. The smartphone includes a smartphone housing, a battery, a radio frequency (RF) circuit, a ten element dual band multiple-input multiple-output (MIMO) antenna, and ten T-shaped feed structures. The battery includes a battery ground terminal and a battery voltage terminal. The battery is located within the smartphone housing. The RF circuit is located within smartphone housing. The RF circuit includes at least a power amplifier connected to the ground terminal and the voltage terminal, a low noise amplifier connected to the power amplifier, a mixer operatively connected to the power amplifier and the low noise amplifier, and an RF circuitry voltage output terminal and an RF circuitry ground terminal. The ten element dual band MIMO antenna is located within the smartphone housing. The ten element dual band MIMO antenna is configured as ten single element dual band antennas. Each antenna of the ten single element dual band antennas is connected to the RF circuitry ground terminal. Each of the T-shaped feed structures is connected to a feed port. Each feed port is connected to the RF circuitry voltage output terminal. The RF circuitry is configured to generate electrical signals and each antenna of the ten element dual band MIMO antenna is configured to radiate at a resonant frequency of about 3.5 GHz in response to the electrical signals received at its respective feed port.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a geometrical representation of a ten element dual band multiple-input multiple-output (MIMO) antenna, according to certain embodiments.

FIG. 1B illustrates distances between two adjacent elements of the ten element dual band MIMO antenna, according to certain embodiments.

FIG. 2 illustrates a functional diagram of the ten element dual band MIMO antenna, according to certain embodiments.

FIG. 3A illustrates a structural diagram of a single element dual band antenna, according to certain embodiments.

FIG. 3B illustrates a structural diagram of the single element dual band antenna with specific parameter values, according to certain embodiments.

FIG. 4 illustrates a block diagram depicting connectivity of the single element antenna with a smartphone, according to certain embodiments.

FIG. 5A illustrates an exemplary circuit diagram of the smartphone having the ten element dual band MIMO antenna, according to certain embodiments.

FIG. 5B illustrates a circuit diagram of a single element of the dual band antenna, according to certain embodiments.

FIG. 6A is an exemplary representation of a first antenna (ant. 1) and a second antenna (ant. 2) when the first antenna (ant 1) is excited, according to certain embodiments.

FIG. 6B is an exemplary representation of the first antenna (ant. 1) and the second antenna (ant. 2) when the second antenna (ant. 2) is excited, according to certain embodiments.

FIG. 7 illustrates the various scattering (S)-parameters curve for the ten element dual band MIMO antenna, according to certain embodiments.

FIG. 8 is a graphical representation depicting efficiencies for the first antenna, the second antenna, a third antenna, and a fourth antenna, according to certain embodiments.

FIG. 9A is a visual representation of the isolation between adjacent antenna elements when ant. 1 is excited, according to certain embodiments.

FIG. 9B is a visual representation of the isolation between adjacent antenna elements when ant. 2 is excited, according to certain embodiments.

FIG. 10 is a graphical representation of the gain versus frequency of the ten element dual band MIMO antenna, according to certain embodiments.

FIG. 11 is a graph showing envelope correlation coefficient versus frequency between different antenna elements, according to certain embodiments.

FIG. 12 is a graph showing the diversity gain of the ten element dual band MIMO antenna at various frequencies, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Mutual coupling between the antenna elements of the MIMO antenna results in degradation of elements isolations and envelope correlation coefficient (ECC) factor, therefore reducing the data capacity and performance of the communication system. To have effective isolation between antenna elements, various configurations have been tried in conventional systems. However, such configurations either limit number of elements of the antenna or render inefficient system performance.

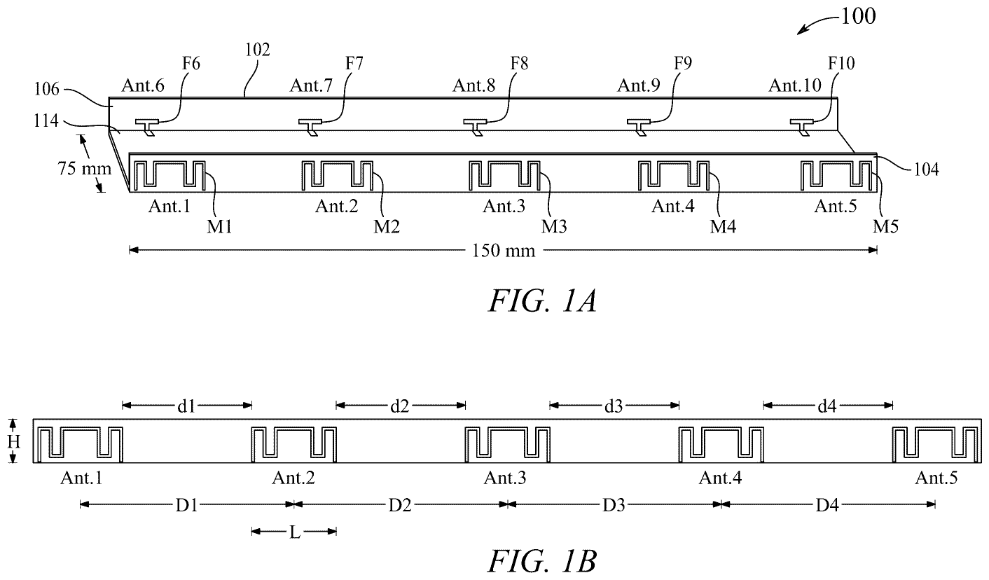

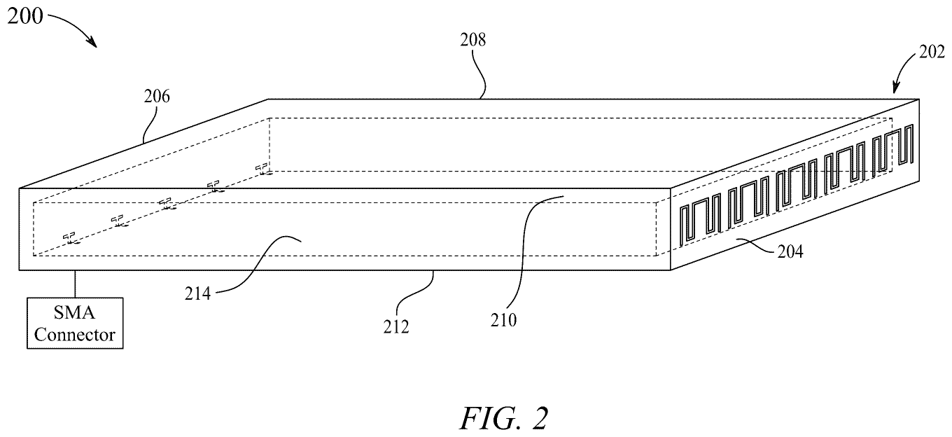

Aspects of this disclosure are directed to a ten-element dual-band MIMO antenna for communication devices (for example, smartphones). In an attempt to reduce mutual coupling between the antenna elements, the ten element dual-band MIMO antenna has a specific antenna element layout in which ten antenna elements are strategically placed on an outer surface of a substrate, and ten T-shaped feed structures are placed on an inner surface of the substrate. FIG. 1A-FIG. 1B illustrate an overall configuration of a ten element dual band multiple-input multiple-output (MIMO) antenna for a smartphone. FIG. 1A-FIG. 1B may be read in conjunction with FIG. 2 for a better understanding. In the drawings of FIG. 1A-FIG. 2, dimensions shown are for the example of a 150×75 mm² circuit board and should not be construed as limiting. For a circuit board less than 150×75 mm², the dimensions are proportionately smaller. Similarly, for a circuit board greater than 150×70 mm², the dimensions are proportionately larger.

FIG. 1A illustrates a geometrical representation of a ten element dual band MIMO antenna 100 (hereinafter interchangeably referred to as “the MIMO antenna 100”). The MIMO antenna 100 includes a substrate 102, a plurality of single element dual band antennas, and a plurality of T-shaped feed structures. For example, the plurality of single element dual band antennas includes ten single element dual band antennas referred to as a first antenna (ant. 1), a second antenna (ant. 2), a third antenna (ant. 3), a fourth antenna (ant. 4), a fifth antenna (ant. 5), a sixth antenna (ant. 6), a seventh antenna (ant. 8), an eighth antenna (ant. 8), a ninth antenna (ant. 9), and a tenth antenna (ant. 10). Each single element dual band antenna of the plurality of single element dual band antennas is connected to a dedicated T-shaped feed structure.

The substrate 102 has a surface dimension of about 150 mm in length and about 75 mm in width. Referring to FIG. 2, the substrate 102 includes a top side 214, a bottom side 212, a first side wall 204, a second side wall 206, a third side wall 208, and a fourth side wall 210. The second side wall 206 is opposite to the first side wall 204. The third side wall 208 is perpendicular to the first side wall 204. The fourth side wall 210 is opposite to the third side wall 208. In one implementation, the walls are placed opposite to each other are parallel or substantially parallel to each other. In an example, the substrate 102 is a flame retardant (FR)-4 lossy dielectric plate. FR-4 (or FR4) is a glass-reinforced epoxy laminate material. FR-4 is a composite material composed of woven fiberglass cloth with an epoxy resin binder that is flame-resistant (self-extinguishing). In an example, a thin layer of copper foil is typically laminated to one or both sides of the FR-4 lossy dielectric plate. In an example, the substrate has a thickness of 0.8 mm.

The MIMO antenna 100 includes the substrate 102 on which various antenna elements are implemented. In an example, the antenna elements may be printed on the substrate 102. The side edge substrate dimensions are 150 mm×6 mm×0.8 mm. A ground plane associated with the antenna elements is fabricated on the substrate 102. In an example, the substrate 102 has a relative permittivity (εr) of 4.4 and a dielectric loss tangent (tan δ) of 0.02.

The ten single element dual band antennas (acting as antenna elements) are evenly distributed into two groups, each containing 5 antenna elements (Ant. 1 to Ant. 5, also referred to as Antenna 1 to Antenna 5, and Ant. 6 to Ant. 10, also referred to as Antenna 6 to Antenna 10). The first five antennas (group 1) of the ten single element dual band antennas are spaced evenly along an outer surface of the first side wall 204 and the second five antennas (group 2) of the ten single element dual band antennas are spaced evenly along an outer surface of the second side wall 206. These groups (for example, group 1 and group 2) are strategically located on the right and left side edges of the primary substrate 102, enhancing the symmetrical aspect of the configuration and facilitating an organized structural layout for optimal functionality.

In a structural aspect, each single element dual band antenna includes a meandered slot line having a first arm and a second arm that helps it to work efficiently at the intended frequency of 3.5 GHz. The meandered slot lines are placed at specific locations, ensuring that the antennas work efficiently and without interfering with each other, promising high-speed and clear communications.

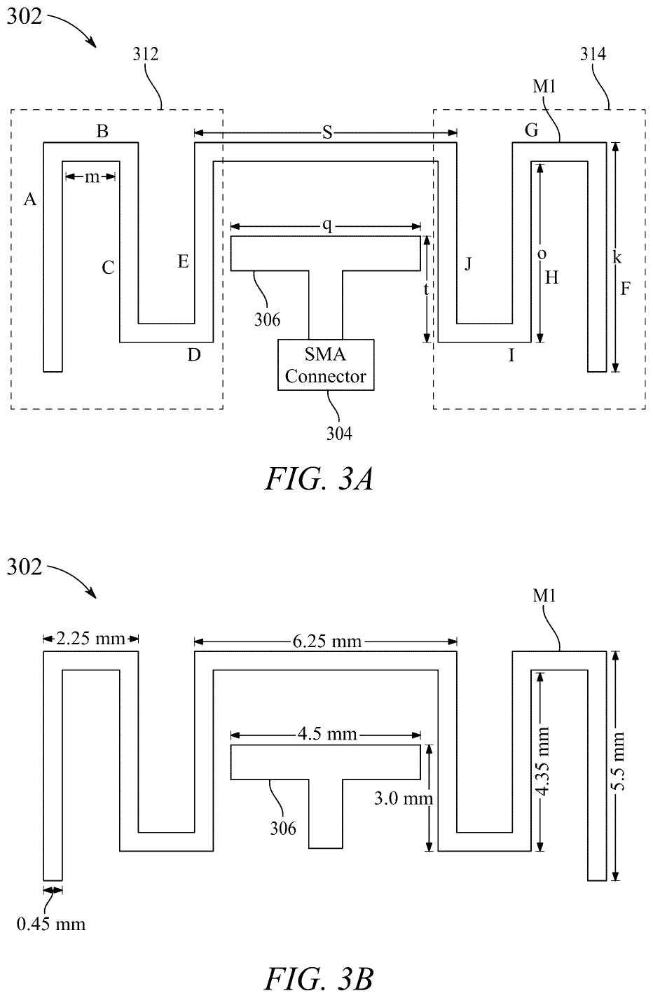

The ten T-shaped feed structure are divided into two groups (explained in more detail in FIG. 3). Each group includes five T-shaped feed structures. The first five of the ten T-shaped feed structures are located an inner surface of the first side wall 204, and a second five of the ten T-shaped feed structures are located on an inner surface of the second side wall 206. Each T-shaped feed structure is connected through to a feed port located on the bottom side. In an example, the feed port is a 50Ω SMA connector. The SMA (SubMiniature version A) connector is configured to transmit high-frequency signals. The 50Ω SMA connector is integrated through holes fabricated at the backside of the substrate 102 system, thereby establishing a robust connection pathway for the antenna elements.

The MIMO antenna 100 includes a ground plane located on the bottom side of the substrate 102.

Each single element dual band antenna is configured to operate efficiently at a resonant frequency of around 3.5 GHZ, such that the MIMO antenna 100 is configured to operate in high-frequency environments, such as modern communication networks.

FIG. 1B illustrates the distances between the adjacent antenna elements of MIMO antenna 100. For example, the group 1 includes five adjacent antenna elements (the antenna 1, the antenna 2, the antenna 3, the antenna 4, and the antenna 5). The distances (spacings) between the five adjacent antenna elements may defined through the variables d1, d2, d3, and d4. The distances between the respective feeds of these five adjacent antenna elements may be shown as D1, D2, D3, and D4, respectively. The relationship between these distances is clearly outlined by the equation D=d+L, where:
1. “D” stands for the distance between the feeds of adjacent antennas.
2. “d” is the inter-element distance between adjacent antennas.
3. “L” represents the length of an antenna element. L=4 (m+n)+l, with “m,” “n,” and “l”, being parameters that represent various dimensional aspects of the antenna element, as shown in FIG. 3A and FIG. 3B.

In one implementation, D is about 33.75 mm, d is about 20.3 mm, L is about 13.45 mm, m is about 2.25 mm and n is about 0.45 mm. The height of the antenna elements is represented by the “H”, which can be varied during design to adjust the impedance matching of the antenna.

FIG. 2 illustrates a functional diagram of the MIMO antenna 100. As described above, the ten elements dual band MIMO antenna is divided into two groups having five single element dual band antennas in each group, referred to as first group and second group. Antennas from each group are arranged along the outer surfaces of the first side wall 204 and the second side wall 206. For example, the first five single element antennas are arranged on the outer surface of the first side wall 204, and rest of the five single element antennas are arranged on the outer surface of the second side wall 206.

FIG. 3A illustrates a structural diagram of the single element antenna 302. The single element antenna 302 includes, but is not limited to, a T-shaped feed structure 306 and a radiating meandered slot line 304. Each T-shaped feed structure 306 is placed at an inner surface a respective side wall. The radiating meandered slot line 304 is placed at an outer surface of the respective wall. For example, the T-shaped feed structure 306 of each single element antenna 302 from the first group of antennas is placed on the inner surface of the first side wall 204, and the radiating meandered slot line 304 is placed on the outer surface of the first side wall 204. Likewise, the T-shaped feed structure 306 of each antenna from the second group is placed on the inner surface of the second side wall 206, and the radiating meandered slot line 304 is placed on the outer surface of the second side wall 206. Flat edges of the of T-shaped feed structure 306 and the radiating meandered slot lines 304 are placed on the surface of walls, as shown in the FIG. 2.

FIG. 3A is an exemplary illustration of the antenna 1. The antenna 1 includes the T-shaped feed structure 306 and the radiating meandered slot line 304 is configured with specific dimensions to enhance of the efficiency and performance of the MIMO antenna 100.

As shown, a defined length of the T-shaped feed structure 306 is denoted by “q”, and the height of the T-shaped feed structure 306 is denoted by “t”.

In one aspect, the radiating meandered slot line 304 has a first arm 312 and a second arm 314. Each arm is represented by a zig-zag pattern. In a structural aspect, the first arm 312 is formed by a first leg A, a second leg B, a third leg C, a fourth leg D, and a fifth leg E. The first leg A is perpendicular to the bottom side 212 of the substrate. A first end of the first leg A is connected to the ground plane and a second end of the first leg A is located near a top edge of a respective sidewall (for example, for group A, the sidewall is 206). Referring to FIG. 3B, in an example, the first leg A has a height of about 5.5 mm. The second leg B includes a first end and a second end. The first end is connected to the second end of the first leg A. The second leg is perpendicular to the first leg. The second leg B is configured to extend towards the second arm 314. In an example, the second leg B has a length of about 2.25 mm.

The third leg C includes a first end and a second end. The first end is connected to the second end of the second leg. The third leg C is perpendicular to the second leg B. The third leg C is configured to extend towards the bottom side 212. In an example, the third leg C has a height of about 4.35 mm. The fourth leg D includes a first end and a second end. The first end is connected to the second end of the third leg C. The fourth leg D is parallel to the bottom side 212 and is configured to extend towards the second arm 314. In an example, the fourth leg D has a length of about 2.25 mm. The fifth leg E includes a first end and a second end. The first end is connected to the second end of the fourth leg D. The fifth leg E is perpendicular to the fourth leg D. The fifth leg E is configured to extend from the bottom side towards the straight leg S. The second end of the fifth leg E is connected to a first end of the straight leg S. In an example, the fifth leg E has a length of about 4.35 mm. In an example, the straight leg S has a length of about 6.25 mm. In one implementation, the thickness of the meandered slot line of each of the first leg, the second leg, the third leg, the fourth leg, the fifth leg and the straight leg is about 0.45 mm.

In a structural aspect, the second arm 314 formed by a first leg F, a second leg G, a third leg H, a fourth leg I, and a fifth leg J. The first leg F is perpendicular to the bottom side 212. A first end of the first leg F is connected to the ground plane and a second end of the first leg F is located near the top edge of a respective sidewall (for example, for group A, sidewall is 206). In an example, the first leg F has a height of about 5.5 mm. The second leg G includes a first end and a second end. The first end is connected to the second end of the first leg F. The second leg G is perpendicular to the first leg F. The second leg G is configured to extend towards the first arm 312. In an example, the second leg G has a length of about 2.25 mm. The third leg H includes a first end and a second end. The first end is connected to the second end of the second leg G. The third leg His perpendicular to the second leg G. The third leg H is configured to extend towards the bottom side 212. In an example, the third leg H has a height of about 4.35 mm. The fourth leg I includes a first end and a second end. The first end is connected to the second end of the third leg H. The fourth leg I is parallel to the bottom side 212 and is configured to extend towards the first arm 312. In an example, the fourth leg I has a length of about 2.25 mm.

The fifth leg J includes a first end and a second end. The first end is connected to the second end of the fourth leg I. The fifth leg J is perpendicular to the fourth leg I. The fifth leg I is configured to extend from the bottom side towards the straight leg S. The second end of the fifth leg I is connected to a first end of the straight leg S. In an example, the fifth leg I has a length of about 4.35 mm. In an example, the straight leg S has a length of about 6.25 mm. In an aspect, the thickness of the meandering line of each of the first leg, the second leg, the third leg, the fourth leg, the fifth leg and the straight leg is about 0.45 mm. As shown, the first arm and the second arm are connected to the ground plane. Each single element dual band antenna has dimensions of about 13.45 mm× about 5.5 mm. FIG. 3B illustrates a structural diagram of the single element antenna 302 with specific parameter values. To further enhance the impedance matching capabilities of the antenna, the T-shaped feed structure 306 and the radiating meandering structure are configured with specific dimensions as described earlier.

The T-shaped feed structure 306 integrates several variables including ‘t’ and ‘q’. The radiating meandering structure integrates several variables including ‘q,’ ‘m,’ ‘o,’ ‘n,’ ‘1,’ ‘L,’ ‘k,’ which have been fine-tuned for defined values to facilitate efficient radiation.

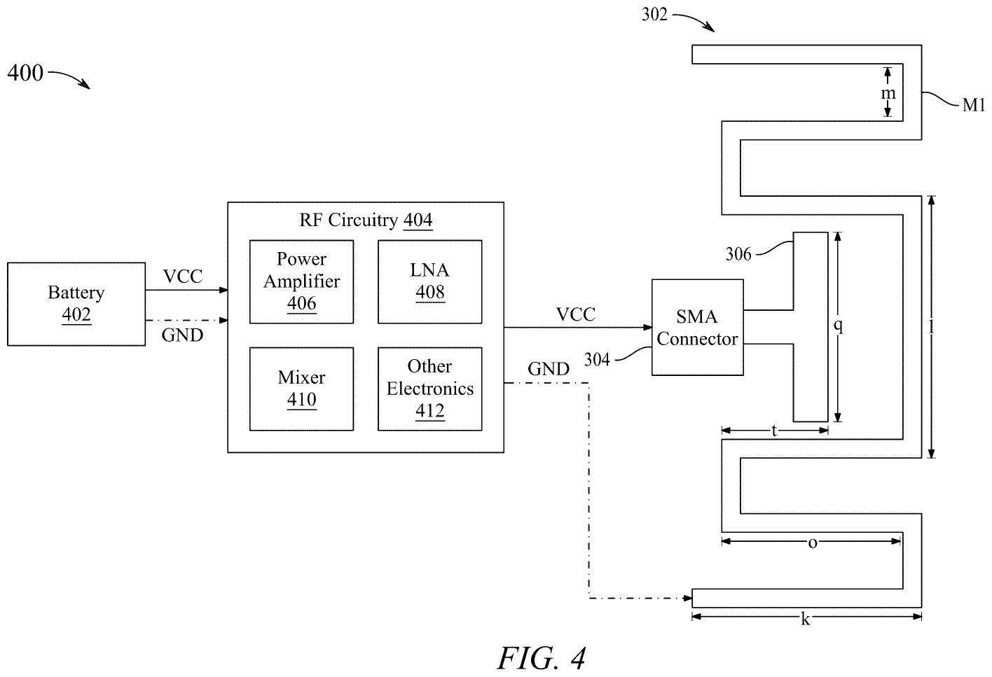

FIG. 4 illustrates a block diagram depicting connectivity of the single element antenna 302 with a smartphone. As shown in FIG. 4, the smartphone includes a smartphone housing (not shown in FIG.), a battery 402, a radio frequency (RF) circuit 404, the single element antennas 302, of which one antenna is shown, and a T-shaped feed structure 306. The RF circuit 404 is powered by the battery 402 of the smartphone. VCC and ground connections of the battery 402 are connected to the RF circuit 404. The RF circuit 404 includes various components which include, but are not limited to, a power amplifier 406, a low noise amplifier (LNA) 408, a mixer 410, and other electronics 412. The power amplifier 406 is connected to the ground terminal and the voltage terminal. The low noise amplifier 408 is connected to the power amplifier 406. The mixer 410 is operatively connected to the power amplifier 406 and the low noise amplifier 408. A voltage output terminal (VCC) and a ground terminal of the RF circuit 404 are connected to the single element antennas 302. The VCC terminal is connected to the feed port (SMA connector) of the T-shaped feed structure 306. The ground terminal is connected to the first leg of each arm of the radiating meandered slot line 304, i.e., legs A and F.

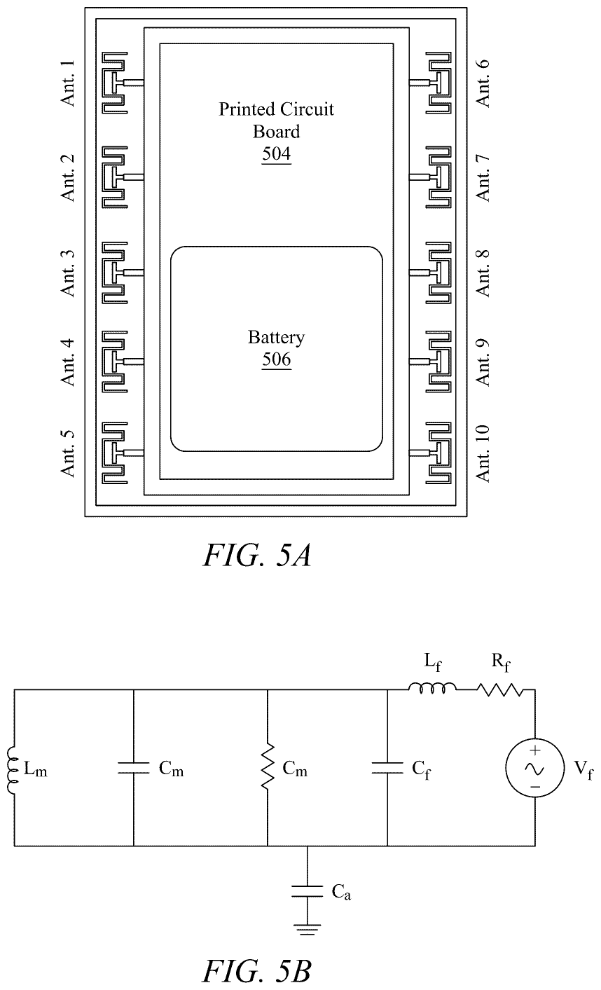

FIG. 5A illustrates an exemplary circuit diagram of the smartphone having the ten element dual band MIMO antenna. As shown in FIG. 5A, ten elements are implemented in the smartphone using a printed circuit board 504 powered by the battery 506. The T-shaped feed structure 306 of each single element antenna 302 is fed by the VCC connection from the printed circuit board 504.

The MIMO antenna elements are printed on the substrate 102 using, for example, an inkjet printing technique. Inkjet printing on the substrate 102 is performed by transferring the circuit design on circuit material. This design can be crafted through graphic design applications or sourced from a pre-existing image through scanning. Subsequently, the ink required for printing undergoes preparation to meet the defined specifications necessitated for the job. The preparation entails combining the ink with solvents or other additives to enhance its functional properties. Following the ink preparation, the ink is loaded into the inkjet printer, aligning concurrently with the placement of the substrate 102 in the designated tray of the printer. The nozzles of the printer meticulously dispense the ink onto the substrate 102, following the pattern dictated by the design. This is achieved through a precise array of nozzles that delineate the ink onto the material in accordance with the mapped-out pattern.

Post printing, a drying period is instituted to allow the ink to settle and dry thoroughly, a duration that varies based on the specifics of the ink and the substrate 102. The drying period can span a few minutes to several hours. The dried printed substrate 102 may undergo further treatments like lamination, cutting, or binding, dictated by the end-use of the product.

FIG. 5B illustrates a circuit diagram of the single element antenna 302 depicting connectivity between various electrical components of the single element antenna 302. R_{f} represents the resistance parameter integrated into the T-shaped feeding line, governing the electrical characteristics and performance of the feedline. L_{f} is the inductance associated with the T-shaped feeding line, defining the resonance properties, and ensuring a stable feed operation. R_{f} and L_{f} components are in series. In one aspect, Rₘ, Lₘ and Cₘ are connected in parallel, and are referred combinedly as to parallel RLC components of the radiating element. The parallel RLC components cumulatively represent the overall parallel resistance inductance and capacitance of the radiating elements, crucial in tuning the antennas resonance frequency and determining its radiation efficacy. C_{f} indicates the capacitive coupling existing between the radiating element and the feeding line, thereby influencing the impedance matching and the bandwidth of the antenna. Cₐ represents the extent of coupling between the antenna element and the ground. Cₐ parameter is configured for determining the ground effects on the performance of the antenna, thus being a vital facet in impedance matching mechanism of the MIMO antenna 100.

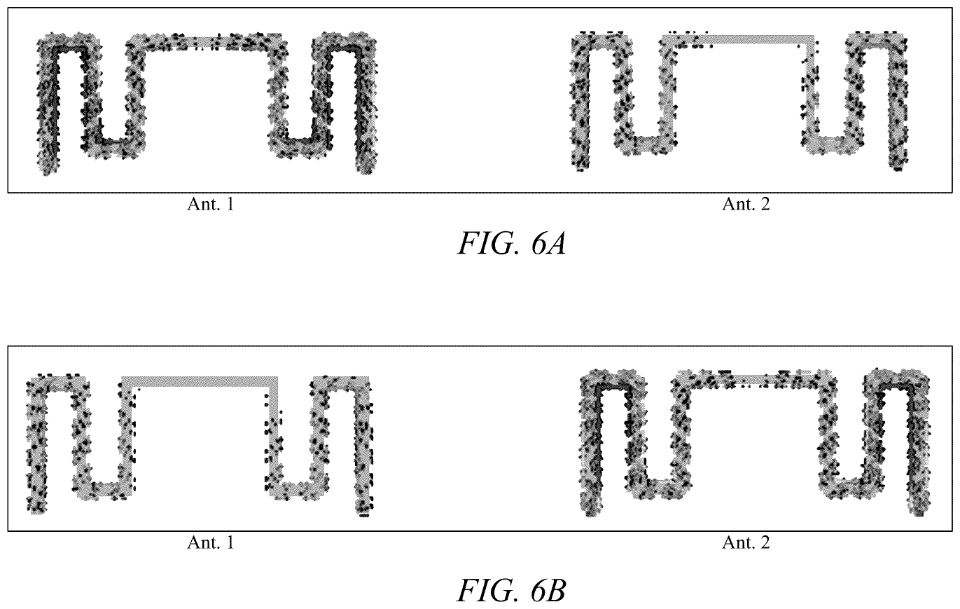

FIG. 6A illustrates placement of the antenna 1 (shown as Ant. 1) and the antenna 2 (shown as Ant. 2) when the Ant. 1 is excited. In an example, the Ant. 1 and Ant. 2 are placed at a center to center distance of 33.75 mm from each other. As illustrated in FIG. 6A, when the Ant. 1 is excited, current distribution can be seen confined within the boundaries of the Ant. 1 significantly.

FIG. 6B illustrates a visual representation of placement of Ant 1 and Ant. 2 when Ant. 2 is excited. Ant. 1 and Ant. 2 are placed at a center to center distance of 33.75 mm from each other. As illustrated in FIG. 6B, Ant. 2 is excited. Current distribution can be seen being confined within the boundaries of Ant. 2 significantly.

From the current distribution analysis, as depicted in FIGS. 6A and 6B, it is evident that every antenna element in the MIMO antenna 100 is isolated. The antenna elements, Ant. 1 and Ant. 2, maintain a low mutual coupling during the respective excitation cycles, results in a self-isolated operational characteristic.

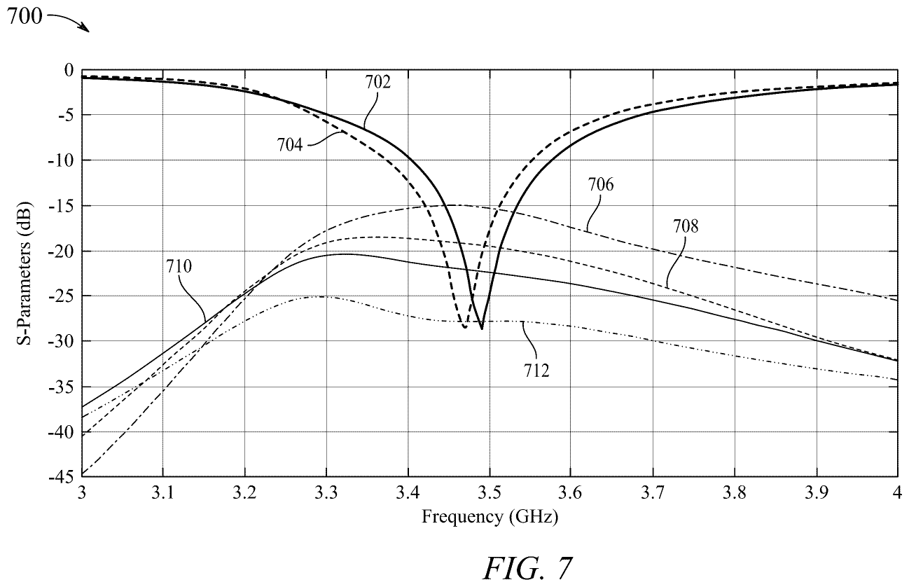

FIG. 7 is a graph 700 illustrating various scattering (S)-parameters curve for the MIMO antenna 100. Scattering parameters or S-parameters, the elements of a scattering matrix or S-matrix, describe the electrical behavior of linear electrical networks when undergoing various steady state stimuli by electrical signals. Signal 702 represents the simulated values of the S₁₁. Signal 704 represents the simulated values of the S₂₂. Signal 706 represents the simulated values of the S₂₁. Signal 708 represents the simulated values of the S₃₁. Signal 710 represents the simulated values of the S₄₁. Signal 712 represents the simulated values of the S₅₁. Curves of the signals 702 and 704 are substantially similar and show good impedance matching at resonant frequency 3.5 GHz. The curve of the signal 706 representing S₂₁ depicts poor isolation but the performance is satisfactory at 15 dB. It can be seen from the graph that the MIMO antenna 100 provided good isolation between adjacent antennas.

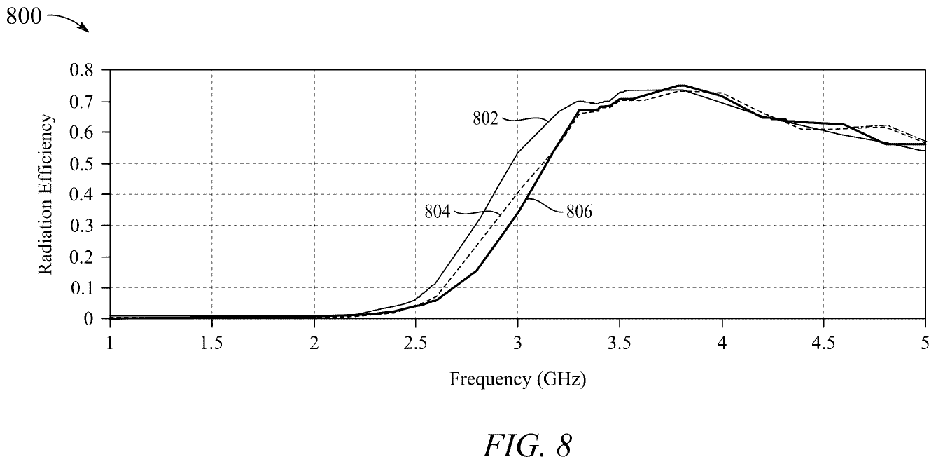

FIG. 8 is a graph 800 depicting radiation efficiencies for the first antenna 1, the second antenna 2, a third antenna 3, and a fourth antenna 4. Curve 802 represents the efficiency for the first antenna 1. Curve 804 represents the radiation efficiency for the second antenna 2 and the fourth antenna 4, which merge due to their symmetry about the third antenna 3. Curve 806 represents the radiation efficiency for the third antenna 3, in which the curves merge. It can be concluded from FIG. 8 that the first antenna Ant. 1, the first antenna 1, the second antenna 2, the third antenna 3 and the fourth antenna 4 have radiation efficiencies greater than 65% within the 3.5 GHz band.

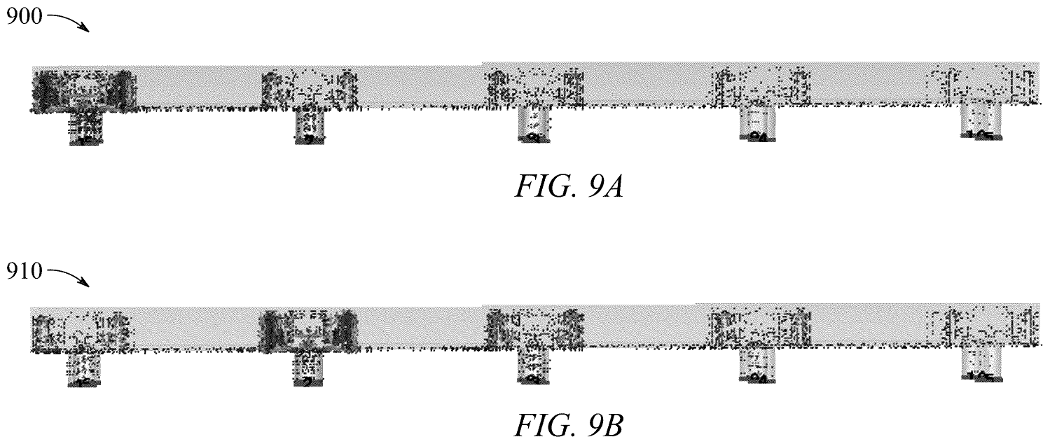

FIG. 9A is a visual representation 900 of the isolation between adjacent antenna elements, when the Ant. 1 is excited.

FIG. 9B is a visual representation 910 of the isolation between adjacent antenna elements, when Ant. 2 is excited.

Referring to FIG. 9A and FIG. 9B, the current distribution attributed to single element excitation and self-isolation characteristic resulting into low mutual coupling of elements can be seen.

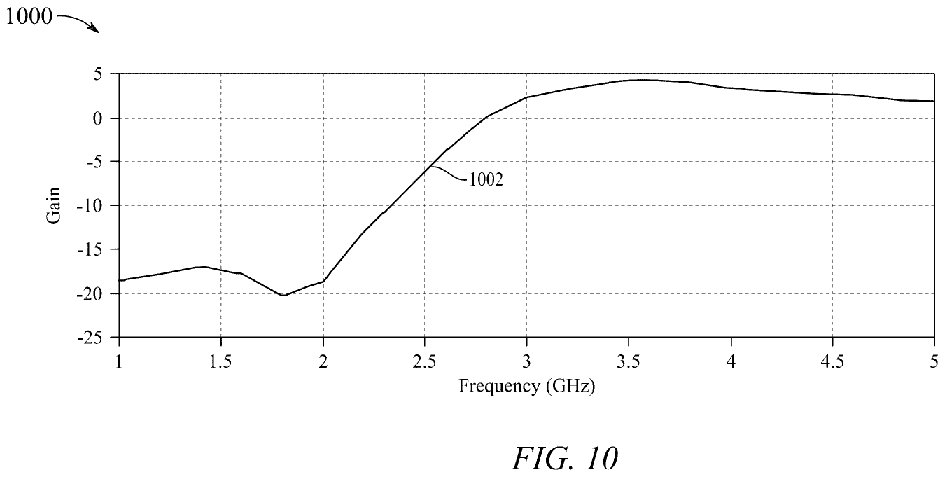

FIG. 10 is a graphical representation 1000 of the gain versus frequency of MIMO antenna 100. Curve 1002 represents the gain of MIMO antenna 100 as the frequency increases. As shown in FIG. 19, a maximum gain achieved was 4.5 dB at 3.5 GHz band as depicted by curve 1002.

For antenna(s) transmitting simultaneous and independent data streams, isolation is required between the antenna(s) such that each of antennas work independently without affecting the performance of the other antennas. The antennas should have good isolation, and their radiation patterns should not be same, or at least not very “correlated”. To measure the isolation between the antennas, the envelope correlation coefficient (ECC) is calculated.

The ECC describes the independence of the radiation patterns between two antennas. For example, if one antenna is completely horizontally polarized, and the other is completely vertically polarized, then the two antennas would have a correlation of zero. In similar manner, if one antenna only radiated energy towards the sky, and the other only radiated energy towards the ground, these antennas would also have an ECC of 0. The ECC is considered as an important factor for accounting the radiation pattern shape, the polarization and a relative phase of the fields between the two antennas. During experiments, the values are found to be very low (0.00125), less than 0.02, ideal for the MIMO operation.

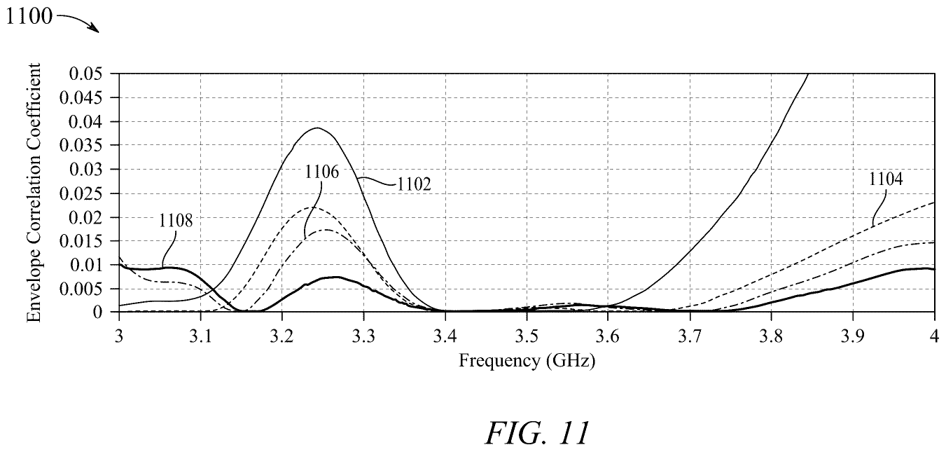

FIG. 11 is a graph 1100 showing the envelope correlation coefficient between different antenna elements. Curve 1102 represents the ECC values between antenna 1 and antenna 2. Curve 1104 represents the ECC values between antenna 1 and antenna 3. Curve 1106 represents the ECC values between antenna 1 and antenna 4. Curve 1108 represents the ECC values between antenna 1 and antenna 5. At the operating frequency of 3.5 GHZ, the EEC is effectively zero between the antennas, which is ideal, as this represents little or no interference between the antenna's radiation patterns.

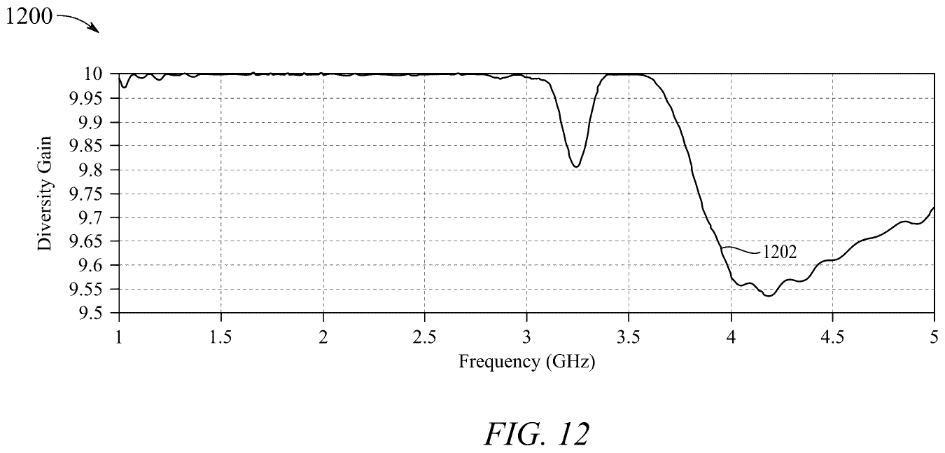

FIG. 12 is a graph 1200 showing the diversity gain of the MIMO antenna. Curve 1202 represents the diversity gain of the MIMO antenna at various frequencies. At the operating frequency of 3.5 GHz, the diversity gain is 10, which represents little or no interference between the antenna's radiation patterns.

The performance of the present MIMO antenna 100 is compared with the aforementioned existing antennas and is summarized in Table 1. It is observed from the table 1 that the present MIMO antenna 100 is efficient in comparison to conventional antennas.

TABLE 1
Summary of performance comparison

| | Parameters | | | | | | |
|---|---|---|---|---|---|---|---|
| | Operating | Dimension of | Dimension | Total | | | |
| | Bands in | Whole MIMO | of Element | Efficiencies | Element | Isolation | |
| Refs. | GHz | System mm³ | Size mm² | (%) | numbers | (dB) | ECC |
| Z. Ren et al. | 3.4-3.6 | 150 × 75 × 6.8 | 17.4 × 6.8 | 60-70 | 8 | >17 | <0.23 |
| K.-L. Wong et al. | 3.4-3.6 | 150 × 75 × 7 | 10 × 3.1 | 42-52 | 8 | >10 | <0.15 |
| C. Deng et al. | 3.4-3.6 | 140 × 70 × 3.2 | 8.8 × 4 | 36-52 | 4 | >11.6 | |
| Z. Xu et al. | 3.4-3.6 | 140 × 70 × 0.8 | 25 × 10.5 | 52-70 | 8 | >14 | <0.16 |
| The present MIMO | 3.4-3.6 | 150 × 75 × 6 | 13.45 × 5.5 | Above 52 | 10 | >15 | <0.00125 |
| antenna 100 | | | | | | | |

The first embodiment is illustrated with respect to FIG. 1-FIG. 12. The first embodiment describes the ten element dual band multiple-input multiple-output (MIMO) antenna for a smartphone. The MIMO antenna includes a substrate 102, ten single element dual band antennas, each single element antenna 302 having a meandered slot line 304 and a T-shaped feed structure 306, and a ground plane.

In one aspect, the substrate 102 has a top side, a bottom side, a first side wall 204, a second side wall 206 opposite the first side wall 204, a third side wall 208 perpendicular to the first side wall 204 and a fourth side wall 210 opposite to the third side wall 208.

In one aspect, the first five antennas of the ten single element dual band antennas are spaced evenly along an outer surface of the first side wall 204. A second five antennas of the ten single element dual band antennas are spaced evenly along an outer surface of the second side wall 206. Each single element dual band antenna includes a meandered slot line 304 having a first arm and a second arm. The first arm and the second arm are connected by a straight leg.

In one aspect, the ten T-shaped feed structure 306 is disclosed. A first five of the ten T-shaped feed structures 306 are located an inner surface of the first side wall 204. A second five of the ten T-shaped feed structures 306 are located on an inner surface of the second side wall 206. Each T-shaped feed structure 306 is located parallel to the straight leg and centered between the first arm and the second arm of a respective antenna.

In one aspect, each T-shaped feed structure 306 is connected through the substrate to a feed port located on the bottom side.

In one aspect, a ground plane located on the bottom side of the substrate 102. The first arm and the second arm are connected to the ground plane.

In one aspect, each antenna of the ten element dual band MIMO antenna is configured to radiate at a resonant frequency of about 3.5 GHz in response to an electrical signal applied to its respective feed port.

In one aspect, the straight leg of the single element antenna 302 has a length of about 6.25 mm.

In one aspect, the meandered slot line 304 includes the first arm and the second arm. Each arm includes a first leg perpendicular to the bottom side. A first end of the first leg is connected to the ground plane and a second end of the first leg is located near a top edge of a respective sidewall.

A second leg of the first arm has a first end connected to a second end of the first leg. The second leg is perpendicular to the first leg, wherein the second leg is configured to extend towards the second arm.

In one aspect, a third leg of the first arm has a first end connected to a second end of the second leg. The third leg is perpendicular to the second leg. The third leg is configured to extend towards the bottom side.

In one aspect, a fourth leg of the first arm has a first end connected to a second end of the third leg. The fourth leg is parallel to the bottom side and is configured to extend towards the second arm.

In one aspect, a fifth leg of the first arm has a first end connected to a second end of the fourth leg. The fifth leg is perpendicular to the fourth leg. The fifth leg is configured to extend from the bottom side towards the straight leg. A second end of the fifth leg is connected to a first end of the straight leg.

In one aspect, the first leg has a length of about 5.5 mm, the second leg has a length of about 2.25 mm, the third leg has a length of about 4.35 mm, the fourth leg has a length of about 2.25 mm, the fifth leg has a length of about 4.35 mm, the straight leg has a length of about 6.25 mm and the thickness of the meandered slot line of each of the first leg, the second leg, the third leg, the fourth leg, the fifth leg and the straight leg is about 0.45 mm.

In one aspect, each second arm includes a first leg perpendicular to the bottom side. A first end of the first leg of the second arm is connected to the ground plane and a second end of the first leg of the second arm is located near a top edge of a respective sidewall. In one aspect, a second leg of the second arm has a first end connected to a second end of the first leg of the second arm. The second leg of the second arm is perpendicular to the first leg of the second arm and the second leg of the second arm is configured to extend towards the first arm. The third leg of the second arm has a first end connected to a second end of the second leg of the second arm. The third leg of the second arm is perpendicular to the second leg of the second arm. The third leg of the second arm is configured to extend towards the bottom side. In one aspect, a fourth leg of the second arm has a first end connected to a second end of the third leg of the second arm. The fourth leg of the second arm is parallel to the bottom side and is configured to extend towards the first arm of the second arm. In one aspect, a fifth leg of the second arm has a first end connected to a second end of the fourth leg of the second arm. The fifth leg of the second arm is perpendicular to the fourth leg of the second arm. The fifth leg of the second arm is configured to extend from the bottom side towards the straight leg of the second arm. A second end of the fifth leg of the second arm is connected to a second end of the straight leg of the second arm.

In one aspect, the first leg has a length of about 5.5 mm, the second leg has a length of about 2.25 mm, the third leg has a length of about 4.35 mm, the fourth leg has a length of about 2.25 mm, the fifth leg has a length of about 4.35 mm, the straight leg has a length of about 6.25 mm, and the thickness of the meandered slot line of each of the first leg, the second leg, the third leg, the fourth leg, the fifth leg and the straight leg is about 0.45 mm.

In one aspect, the substrate 102 has dimensions of about 150 mm by about 75 mm by about 0.8 mm.

In one aspect, each single element dual band antenna has dimensions of about 13.45 mm×about 5.5 mm.

In one aspect, each feed port is a 50 (SMA connector.

In one aspect, each sidewall has a thickness of about 0.8 mm.

In one aspect, each antenna element is separated from an adjacent antenna element by an interelement distance d.

In one aspect, each T-shaped feed structure 306 is separated from an adjacent T-shaped feed structure 306 by a feed separation distance D, wherein D equals d+L, where L is a length of an antenna element.

In one aspect, dis about 20.3 mm, D is about 33.75 mm and L is about 13.45 mm.

In one aspect, a height of each T-shaped feed structure 306 is about 3.0 mm and a width of the T-shape is about 4.5 mm.

In accordance with an embodiment, a smartphone includes a ten element dual band MIMO antenna. The smartphone includes a smartphone housing. The smartphone also includes a battery 402 including a battery 402 ground terminal and a battery 402 voltage terminal. The battery 402 is located within the smartphone housing. The smartphone further includes a radio frequency (RF) circuit located within smartphone housing. The RF circuit includes, but is not limited to, a power amplifier 406 connected to the ground terminal and the voltage terminal, a low noise amplifier 408 connected to the power amplifier 406, a mixer 410 operatively connected to the power amplifier 406 and the low noise amplifier 408, an RF circuit 404 voltage output terminal, and an RF circuit 404 ground terminal.

In one aspect, the smartphone includes a ten element dual band multiple-input multiple-output (MIMO) antenna located within the smartphone housing. The ten element dual band MIMO antenna is configured as ten single element dual band antenna elements. Each antenna element of the ten single element dual band antennas is connected to the RF circuitry 404 ground terminal.

In one aspect, the MIMO antenna includes ten T-shaped feed structures 306. Each of the T-shaped feed structures 306 is connected to a feed port. Each feed port is connected to the RF circuitry 404 voltage output terminal.

In one aspect, the RF circuitry 404 is configured to generate electrical signals and each antenna element of the ten element dual band MIMO antenna is configured to radiate at a resonant frequency of about 3.5 GHz in response to the electrical signals received at its respective feed port.

In one aspect, a substrate 102 is located in the housing. The substrate 102 has a top side, a bottom side, a first side wall 204, a second side wall 206 opposite the first side wall 204, a third side wall 208 perpendicular to the first side wall 204 and a fourth side wall 210 opposite to the third side wall 208.

In one aspect, a first five antennas of the ten single element dual band antennas are spaced evenly along an outer surface of the first side wall 204 and a second five antennas of the ten single element dual band antennas are spaced evenly along an outer surface of the second side wall 206. Each single element dual band antenna includes a meandered slot line 304 having a first arm and a second arm. The first arm and the second arm are connected by a straight leg,

In one aspect, a first five of the ten T-shaped feed structures 306 are located an inner surface of the first side wall 204 and a second five of the ten T-shaped feed structures 306 are located on an inner surface of the second side wall 206. Each T-shaped feed structure 306 is located parallel to the straight leg and centered between the first arm and the second arm of a respective antenna element.

In one aspect, the feed port is located on the bottom side.

In one aspect, a ground plane located on the bottom side of the substrate 102. The first arm and the second arm are connected to the ground plane.

In one aspect, each first arm includes a first leg perpendicular to the bottom side. A first end of the first leg is connected to the ground plane and a second end of the first leg is located near a top edge of a respective sidewall.

In one aspect, a second leg of the first arm has a first end connected to a second end of the first leg of the first arm. The second leg of the first arm is perpendicular to the first leg. The second leg of the first arm is configured to extend towards the second arm.

In one aspect, a third leg of the first arm has a first end connected to a second end of the second leg of the first arm. The third leg of the first arm is perpendicular to the second leg of the first arm. The third leg of the first arm is configured to extend towards the bottom side.

In one aspect, a fourth leg of the first arm has a first end connected to a second end of the third leg of the first arm. The fourth leg of the first arm is parallel to the bottom side and is configured to extend towards the second arm.

In one aspect, a fifth leg of the first arm has a first end connected to a second end of the fourth leg of the first arm. The fifth leg of the first arm is perpendicular to the fourth leg of the first arm. The fifth leg of the first arm is configured to extend from the bottom side towards the straight leg. A second end of the fifth leg of the first arm is connected to a first end of the straight leg of the first arm.

In one aspect, each second arm includes a first leg perpendicular to the bottom side. A first end of the first leg is connected to the ground plane and a second end of the first leg of the second arm is located near a top edge of a respective sidewall.

In one aspect, a second leg of the second arm has a first end connected to a second end of the first leg of the second arm. The second leg of the second arm is perpendicular to the first leg of the second arm. The second leg of the second arm is configured to extend towards the first arm.

In one aspect, a third leg of the second arm has a first end connected to a second end of the second leg of the second arm. The third leg of the second arm is perpendicular to the second leg of the second arm. The third leg of the second arm is configured to extend towards the bottom side.

In one aspect, a fourth leg of the second arm has a first end connected to a second end of the third leg of the second arm. The fourth leg of the second arm is parallel to the bottom side and is configured to extend towards the first arm.

In one aspect, a fifth leg of the second arm has a first end connected to a second end of the fourth leg of the second arm. The fifth leg of the second arm is perpendicular to the fourth leg of the second arm. The fifth leg of the second arm is configured to extend from the bottom side towards the straight leg of the second arm. A second end of the fifth leg of the second arm is connected to a second end of the straight leg of the second arm.

In one aspect, each antenna is separated from an adjacent antenna by an interelement distance d, and each T-shaped feed structure 306 is separated from an adjacent T-shaped feed structure 306 by a feed separation distance D. D equals d+L, where L is a length of an antenna element.

In one aspect, a printed circuit board is located within the smartphone housing. The battery 402, the power amplifier 406, the low noise amplifier 408 and the mixer 410 are located on the printed circuit board.

In one aspect, the first five antennas are ink jet printed on the outer surface of the first side wall 204 of the substrate 102 and the second five antennas are ink jet printed on the outer surface of the second side wall 206 of the substrate 102.

In one aspect, the first five of the ten T-shaped feed structure 306 are ink jet printed on an inner surface of the first side wall 204 and a second five of the ten T-shaped feed structure 306 are ink jet printed on an inner surface of the second side wall 206.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A ten element dual band multiple-input multiple-output (MIMO) antenna for a smartphone, comprising:
a substrate having a top side, a bottom side, a first side wall, a second side wall opposite the first side wall, a third side wall perpendicular to the first side wall and a fourth side wall opposite to the third side wall;
ten single element dual band antennas, wherein a first five antennas of the ten single element dual band antennas are spaced evenly along an outer surface of the first side wall and a second five antennas of the ten single element dual band antennas are spaced evenly along an outer surface of the second side wall, wherein each single element dual band antenna includes a meandered slot line having a first arm and a second arm, wherein the first arm and the second arm are connected by a straight leg;
ten T-shaped feed structures, wherein a first five of the ten T-shaped feed structures are located an inner surface of the first side wall and a second five of the ten T-shaped feed structures are located on an inner surface of the second side wall, wherein each T-shaped feed structure is located parallel to the straight leg and centered between the first arm and the second arm of a respective antenna;
wherein each T-shaped feed structure is connected through the substrate to a feed port located on the bottom side;
a ground plane located on the bottom side of the substrate, wherein the first arm and the second arm are connected to the ground plane; and
wherein each antenna of the ten element dual band MIMO antenna is configured to radiate at a resonant frequency of about 3.5 GHz in response to an electrical signal applied to its respective feed port.

2. The ten element dual band MIMO antenna of claim 1, wherein the straight leg has a length of about 6.25 mm.

3. The ten element dual band MIMO antenna of claim 1, wherein each first arm comprises:
a first leg perpendicular to the bottom side, wherein a first end of the first leg is connected to the ground plane and a second end of the first leg is located near a top edge of a respective sidewall;
a second leg having a first end connected to a second end of the first leg, wherein the second leg is perpendicular to the first leg and wherein the second leg is configured to extend towards the second arm;
a third leg having a first end connected to a second end of the second leg, wherein the third leg is perpendicular to the second leg, wherein the third leg is configured to extend towards the bottom side;
a fourth leg having a first end connected to a second end of the third leg, wherein the fourth leg is parallel to the bottom side and is configured to extend towards the second arm; and
a fifth leg having a first end connected to a second end of the fourth leg, wherein the fifth leg is perpendicular to the fourth leg, wherein the fifth leg is configured to extend from the bottom side towards the straight leg, wherein a second end of the fifth leg is connected to a first end of the straight leg.

4. The ten element dual band MIMO antenna of claim 3, wherein the first leg has a length of about 5.5 mm, the second leg has a length of about 2.25 mm, the third leg has a length of about 4.35 mm, the fourth leg has a length of about 2.25 mm, the fifth leg has a length of about 4.35 mm, the straight leg has a length of about 6.25 mm and the thickness of the meandered slot line of each of the first leg, the second leg, the third leg, the fourth leg, the fifth leg and the straight leg is about 0.45 mm.

5. The ten elements dual band MIMO antenna of claim 1, wherein each second arm comprises:
a first leg perpendicular to the bottom side, wherein a first end of the first leg is connected to the ground plane and a second end of the first leg is located near a top edge of a respective sidewall;
a second leg having a first end connected to a second end of the first leg, wherein the second leg is perpendicular to the first leg and wherein the second leg is configured to extend towards the first arm;
a third leg having a first end connected to a second end of the second leg, wherein the third leg is perpendicular to the second leg, wherein the third leg is configured to extend towards the bottom side;
a fourth leg having a first end connected to a second end of the third leg, wherein the fourth leg is parallel to the bottom side and is configured to extend towards the first arm; and
a fifth leg having a first end connected to a second end of the fourth leg, wherein the fifth leg is perpendicular to the fourth leg, wherein the fifth leg is configured to extend from the bottom side towards the straight leg, wherein a second end of the fifth leg is connected to a second end of the straight leg.

6. The ten element dual band MIMO antenna of claim 5, wherein the first leg has a length of about 5.5 mm, the second leg has a length of about 2.25 mm, the third leg has a length of about 4.35 mm, the fourth leg has a length of about 2.25 mm, the fifth leg has a length of about 4.35 mm, the straight leg has a length of about 6.25 mm and the thickness of the meandered slot line of each of the first leg, the second leg, the third leg, the fourth leg, the fifth leg and the straight leg is about 0.45 mm.

7. The ten element dual band MIMO antenna of claim 1, wherein the substrate has dimensions of about 150 mm by about 75 mm by about 0.8 mm.

8. The ten element dual band MIMO antenna of claim 1, wherein each single element dual band antenna has dimensions of about 13.45 mm× about 5.5 mm.

9. The ten element dual band MIMO antenna of claim 1, wherein each feed port is a 50Ω SMA connector.

10. The ten element dual band MIMO antenna of claim 1, wherein each sidewall has a thickness of about 0.8 mm.

11. The ten element dual band MIMO antenna of claim 1, wherein each antenna is separated from an adjacent antenna by an interelement distance d.

12. The ten element dual band MIMO antenna of claim 11, wherein each T-shaped feed structure is separated from an adjacent T-shaped feed structure by a feed separation distance D, wherein D equals d+L, where L is a length of an antenna element.

13. The ten element dual band MIMO antenna of claim 12, wherein dis about 20.3 mm, D is about 33.75 mm and L is about 13.45 mm.

14. The ten element dual band MIMO antenna of claim 1, wherein a height of each T-shaped feed structure is about 3.0 mm and a width of the T-shape is about 4.5 mm.

15. A smartphone including a ten element dual band MIMO antenna, comprising:
a smartphone housing;
a battery including a battery ground terminal and a battery voltage terminal, wherein the battery is located within the smartphone housing;
a radio frequency (RF) circuit located within smartphone housing, the RF circuit including at least:
a power amplifier connected to the ground terminal and the voltage terminal;
a low noise amplifier connected to the power amplifier;
a mixer operatively connected to the power amplifier and the low noise amplifier;
an RF circuitry voltage output terminal and an RF circuitry ground terminal;
a ten element dual band multiple-input multiple-output (MIMO) antenna located within the smartphone housing, wherein the ten element dual band MIMO antenna is configured as ten single element dual band antennas, wherein each antenna element of the ten single element dual band antennas is connected to the RF circuitry ground terminal;
ten T-shaped feed structures, wherein each of the T-shaped feed structures is connected to a feed port, wherein each feed port is connected to the RF circuitry voltage output terminal;
wherein the RF circuitry is configured to generate electrical signals and each antenna element of the ten element dual band MIMO antenna is configured to radiate at a resonant frequency of about 3.5 GHz in response to the electrical signals received at its respective feed port.

16. The smartphone of claim 15, further comprising:
a substrate located in the housing, the substrate having a top side, a bottom side, a first side wall, a second side wall opposite the first side wall, a third side wall perpendicular to the first side wall and a fourth side wall opposite to the third side wall;
wherein a first five antenna elements of the ten single element dual band antennas are spaced evenly along an outer surface of the first side wall and a second five antenna elements of the ten single element dual band antennas are spaced evenly along an outer surface of the second side wall, wherein each dual band antenna element includes a meandered slot line having a first arm and a second arm, wherein the first arm and the second arm are connected by a straight leg,
wherein a first five of the ten T-shaped feed structures are located an inner surface of the first side wall and a second five of the ten T-shaped feed structures are located on an inner surface of the second side wall, wherein each T-shaped feed structure is located parallel to the straight leg and centered between the first arm and the second arm of a respective antenna;
wherein the feed port is located on the bottom side, and
a ground plane located on the bottom side of the substrate, wherein the first arm and the second arm are connected to the ground plane.

17. The smartphone of claim 16, wherein each first arm comprises:
a first leg perpendicular to the bottom side, wherein a first end of the first leg is connected to the ground plane and a second end of the first leg is located near a top edge of a respective sidewall;
a second leg having a first end connected to a second end of the first leg, wherein the second leg is perpendicular to the first leg and wherein the second leg is configured to extend towards the second arm;
a third leg having a first end connected to a second end of the second leg, wherein the third leg is perpendicular to the second leg, wherein the third leg is configured to extend towards the bottom side;
a fourth leg having a first end connected to a second end of the third leg, wherein the fourth leg is parallel to the bottom side and is configured to extend towards the second arm; and
a fifth leg having a first end connected to a second end of the fourth leg, wherein the fifth leg is perpendicular to the fourth leg, wherein the fifth leg is configured to extend from the bottom side towards the straight leg, wherein a second end of the fifth leg is connected to a first end of the straight leg.

18. The smartphone of claim 16, wherein each second arm comprises:
a first leg perpendicular to the bottom side, wherein a first end of the first leg is connected to the ground plane and a second end of the first leg is located near a top edge of a respective sidewall;
a second leg having a first end connected to a second end of the first leg, wherein the second leg is perpendicular to the first leg and wherein the second leg is configured to extend towards the first arm;
a third leg having a first end connected to a second end of the second leg, wherein the third leg is perpendicular to the second leg, wherein the third leg is configured to extend towards the bottom side;
a fourth leg having a first end connected to a second end of the third leg, wherein the fourth leg is parallel to the bottom side and is configured to extend towards the first arm; and
a fifth leg having a first end connected to a second end of the fourth leg, wherein the fifth leg is perpendicular to the fourth leg, wherein the fifth leg is configured to extend from the bottom side towards the straight leg, wherein a second end of the fifth leg is connected to a second end of the straight leg.

19. The smartphone of claim 16, wherein:
each antenna element is separated from an adjacent antenna element by an interelement distance d; and
each T-shaped feed structure is separated from an adjacent T-shaped feed structure by a feed separation distance D, wherein D equals d+L, where L is a length of an antenna element.

20. The smartphone of claim 16, further comprising:
a printed circuit board located within the smartphone housing, wherein the battery, the power amplifier, the low noise amplifier and the mixer are located on the printed circuit board;
the first five antenna elements are ink jet printed on the outer surface of the first side wall of the substrate and the second five antenna elements are ink jet printed on the outer surface of the second side wall of the substrate; and
the first five of the ten T-shaped feed structures are ink jet printed on an inner surface of the first side wall and a second five of the ten T-shaped feed structures are ink jet printed on an inner surface of the second side wall.
